(19) United States
(12) Patent Application Publication
(10) Pub. No.: US 2012/0105663 A1
(43) Pub. Date: May 3, 2012

(54) Haptic Feedback Response

(76) Inventor: Robert P. Cazier, Fort Collins, CO (US)

(21) Appl. No.: 12/917,222

(22) Filed: Nov. 1, 2010

(51) Int. Cl. H04N 5/228

(52) U.S. Cl. 348/222.1

(57) ABSTRACT

A device to capture an image with an image capture component, determine whether the image is acceptable in response to a device applying at least one image detection algorithm on the image, and provide a haptic feedback response to a user of the device if the image is acceptable.

### BACKGROUND

When reviewing one or more images captured by an image capture device, a user can couple the image capture device to a computing machine and proceed to transfer the images to review on a display device. The user can use the computing machine to apply one or more filter tests to the image. Alternatively, the user can manually inspect the images with a display device of the image capture device and/or apply one or more filter tests available on the image capture device. The image capture device can then provide one or more responses through the display device for the user to view.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with an image capture component and a motor according to an embodiment.

FIG. 2A illustrates a device with a motor, an input device, and an image capture component according to an embodiment.

FIG. 2B illustrates a device with an image, a display device, an audio speaker, and a motor according to an embodiment.

FIG. 3 illustrates a block diagram of a processor determining whether an image is acceptable according to an embodiment.

FIG. 4A illustrates a block diagram of a motor providing a haptic feedback response in response to a processor determining that an image is acceptable according to an embodiment.

FIG. 4B illustrates a block diagram of a motor providing a second haptic feedback response in response to a processor determining that an image is unacceptable according to an embodiment.

FIG. 5 illustrates an image application on a device and the image application stored on a removable medium being accessed by the device according to an embodiment.

FIG. 6 is a flow chart illustrating a method for providing feedback for an image according to an embodiment.

FIG. 7 is a flow chart illustrating a method for providing feedback for an image according to another embodiment.

### DETAILED DESCRIPTION

By capturing an image with an image capture component, a device can proceed to determine whether the image is acceptable by applying one or more image detection algorithms on the image. In response, the device can provide a haptic feedback response to a user of the device if the image is determined to be acceptable. As a result, distractions can be reduced and a user friendly experience can be created for the user by allowing the user to continue capture additional images with the device while being provided a haptic feedback response when an image is determined to be acceptable.

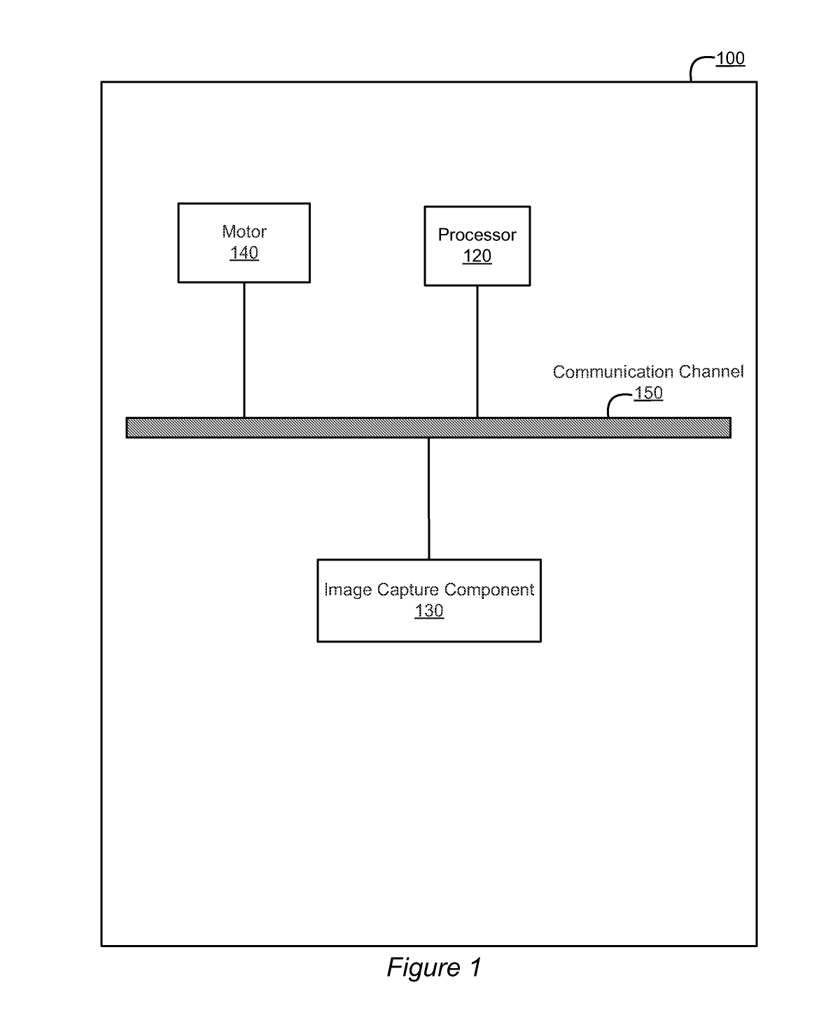

FIG. 1 illustrates a device 100 with an image capture component 130 and a motor according 140 to an embodiment. In one embodiment, the device 100 is an image capture device such as a digital camera. In another embodiment, the device 100 is a device which includes an image capture component 130, such as a cellular device, a PDA device, an E-Reader, and/or the like. In other embodiments, the device 100 is or includes a desktop, a laptop, a notebook, a tablet, a netbook, an all-in-one system, a server, and/or any additional device which can include an image capture component 130 and a motor 140.

As illustrated in FIG. 1, the device 100 includes a processor 120, an image capture component 130, a motor 140 and a communication channel 150 for the device 100 and/or one or more components of the device 100 to communicate with one another. In one embodiment, the device 100 additionally includes a storage device and an image application stored and executable from one or more locations on the device 100. In other embodiments, the device 100 includes additional components and/or is coupled to additional components in addition to and/or in lieu of those noted above and illustrated in FIG. 1.

As noted above, the device 100 includes a processor 120. The processor 120 can send data and/or instructions to the components of the device 100, such as the image capture component 130, the motor 140, and/or the image application. Additionally, the processor 120 can receive data and/or instructions from components of the device 100, such as the image capture component 130, the motor 140, and/or the image application.

The image application is an application which can be utilized in conjunction with the processor 120 to manage the device 100. In one embodiment, the image application can be a firmware of the device 100. The image capture component 130 can initially capture one or more images for the device 100. For the purposes of this application, an image can be a digital image which includes one or more objects or persons captured within a view of the image capture component 130. In response to the image capture component 130 capturing an image, the processor 120 and/or the image application can proceed to determine whether the image is acceptable or unacceptable by applying one or more image detection algorithms to the image.

In one embodiment, one or more image detection algorithms can include a smile detection algorithm, a blink detection algorithm, a face detection algorithm, a focus detection algorithm, a contrast detection algorithm, a color detection algorithm, and/or a brightness detection algorithm. The processor 120 and/or the image application can determine that the image is acceptable if the image passes one or more of the image detection algorithms. The image can be determined to be unacceptable if the processor 120 and/or the image application determine that the image fails one or more of the image detection algorithms.

If the image is determined to be acceptable, the processor 120 and/or the image application can configure a motor 140 of the device 100 to provide a haptic feedback response. In another embodiment, if the image is determined to be unacceptable, the processor 120 and/or the image application can configure the motor 140 to provide a second haptic feedback. For the purposes of this application, a haptic feedback response can be a tactile feedback which a user of the device 100 can feel.

The motor 140 is a component or device which can vibrate or move one or more components of the device 100 when providing a haptic feedback response and/or a second haptic feedback response. By using a motor to provide one or more haptic feedback responses, a user can continue to use the device 100 to capture one or more images while being notified when an image is determined to be acceptable and/or when the image is determined to be unacceptable.

The image application can be firmware which is embedded onto the processor 120, the device 100, and/or the storage device of the device 100. In another embodiment, the image application is an application stored on the device 100 within ROM or on the storage device accessible by the device 100. In other embodiments, the image application is stored on a computer readable medium readable and accessible by the device 100 or the storage device from a different location.

Additionally, in one embodiment, the storage device is included in the device 100. In other embodiments, the storage device is not included in the device 100, but is accessible to the device 100 utilizing a network interface included in the device 100. The network interface can be a wired or wireless network interface card. In other embodiments, the storage device can be configured to couple to one or more ports or interfaces on the device 100 wirelessly or through a wired connection.

In a further embodiment, the image application is stored and/or accessed through a server coupled through a local area network or a wide area network. The image application communicates with devices and/or components coupled to the device 100 physically or wirelessly through a communication bus 150 included in or attached to the device 100. In one embodiment the communication bus 150 is a memory bus. In other embodiments, the communication bus 150 is a data bus.

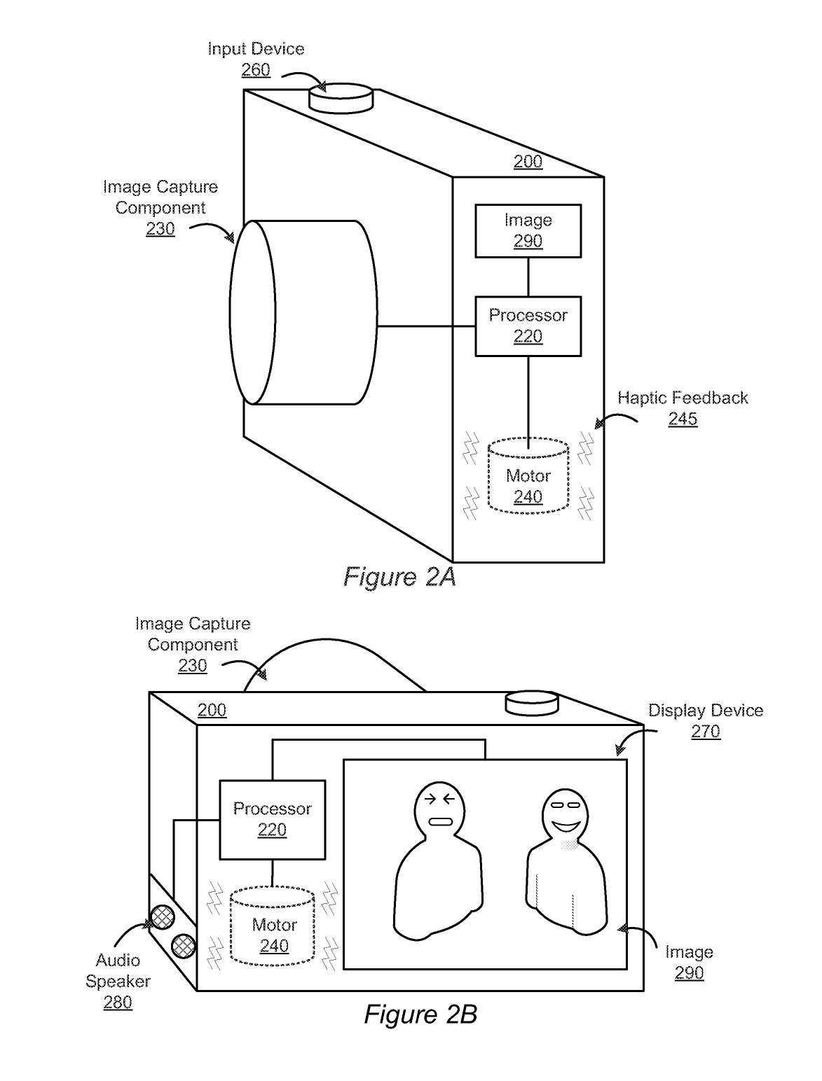

FIG. 2A illustrates a device 200 with a motor 240, an input device 260, and an image capture component 230 according to an embodiment. As illustrated in FIG. 2A, the device 200 can include one or more motors 240. A motor 240 can be a device or component which can generate one or more motions or vibrations when providing one or more haptic feedback responses 245 to a user of the device 200. In another embodiment, the motor 240 can apply force to the device 200 or one or more component of the device 200 when generating a haptic feedback response 245. As noted above, a haptic feedback response 245 can include a tactile feedback which a user of the device 200 can feel. The user can be any person which can access and/or use the device 200.

The motor 240 can be configured by the processor 220 and/or the image application to create and/or generate one or more haptic feedback responses 245. One or more of the haptic feedback responses can differ from one another. In one embodiment, a haptic feedback response 245 can be or include a short vibration. In another embodiment, a haptic feedback response 245 can be or include a long or continuous vibration.

In other embodiments, a haptic feedback response 245 can be or include one or more sequence of vibrations or motions. By generating one or more vibrations or motions with the motor 240, a user of the device 200 can feel the device 200 or one or more components of the device 200 vibrating or moving. The user can feel one or more haptic feedback responses when holding the device 200 or when the device is touching one or more parts of the user's body.

As noted above, a haptic feedback response 245 can be generated if a processor 220 and/or an image application of the device 200 determine that an image 290 is acceptable. In another embodiment, a second haptic feedback response 245 can be generated if the processor 220 and/or the image application determine that an image 290 is unacceptable. One or more images 290 can be digital images of one or more objects or people captured within a view of an image capture component 230. In one embodiment, one or more of the images 290 can be stored as digital image files on one or more locations of the device 200, such as a storage device.

As illustrated in FIG. 2A, the image capture component 230 can be a device or component coupled to the device 200 and configured to capture or record one or more objects or people within a view of the image capture component 230. In response to recording or capturing one or more objects or people within the view, the image capture component 230, the processor 220, and/or the image application can generate one or more of the images 290. A processor 220 and/or an image application of the device 200 can prompt or instruct the image capture component 230 of the device 200 to capture one or more images 290 in response to an input device 260 of the device 200 being accessed.

As illustrated in FIG. 2A, the input device 260 can be coupled to one or more locations on the device 200. The input device 260 can be a mechanical or electrical component which can prompt or trigger the image capture component 230 to capture one or more images 290 in response to being accessed by a user of the device 200. In one embodiment, the input device 260 includes a button which the user can press when accessing the input device 260. In another embodiment, the input device 260 includes one or more touch panels which the user can touch when accessing the input device 260. In other embodiments, the input device 260 can be or include additional components which a user can access to prompt and/or trigger the image capture component 230 to capture one or more images 290 in addition to and/or in lieu of those noted above and illustrated in FIG. 2A.

In other embodiments, the image capture component 230 can capture one or more of the images 290 without the input device 260 being accessed. The processor 220 and/or the image application can instruct the image capture component 230 to capture or record one or more images 290 automatically after a predefined amount of time and/or in response to an event being detected. The event can include the image capture component 230 detecting one or more people or objects within a view of the image capture component 230. In another embodiment, the event can include the device 200, the processor 220, and/or the image application detecting or receiving an instruction from another device.

FIG. 2B illustrates a device 200 with an image 290, a display device 270, an audio speaker 280, and a motor 240 according to an embodiment. As noted above, an image capture component 230 of the device 200 can capture or record one or more images 290. As illustrated in FIG. 2B, an image 290 can include one or more people captured by the image capture component 230. In other embodiments, an image 290 can include one or more objects or scenes. In response capturing an image 290, a processor 220 and/or an image application 210 can determine whether the image 290 is acceptable or unacceptable.

The processor 220 and/or the image application can then configure the motor 240 to provide one or more haptic feedback responses. As noted above, one or more haptic feedback responses can be generated in response to the motor 240 vibrating, moving, and/or applying force to one or more components of the device 200. As illustrated in the present embodiment, the device 200 can additionally include an audio speaker 280 and/or a display device 270 to output one or more messages to supplement a haptic feedback response.

An audio speaker 280 can be an audio component configured to output one or more audio messages. A display device 270 is a component or device which can render and/or display one or more visual messages. In one embodiment, the display device 270 can additionally display one or more of the images 290. The display device 270 can be a LCD (liquid crystal display), a LED (light emitting diode) display, a CRT (cathode ray tube) display, a plasma display, and/or a projector.

One or more messages can be visual and/or audio messages which can supplement a haptic feedback response from the motor 240. In one embodiment, a message from the display device 270 and/or the audio speaker 280 can specify which of the image detection algorithms a corresponding image 290 passed or failed. In another embodiment, a message can specify which user or object within the corresponding image 290 failed an image detection algorithm. In other embodiments, one or more messages can output additional information in addition to and/or in lieu of those noted above.

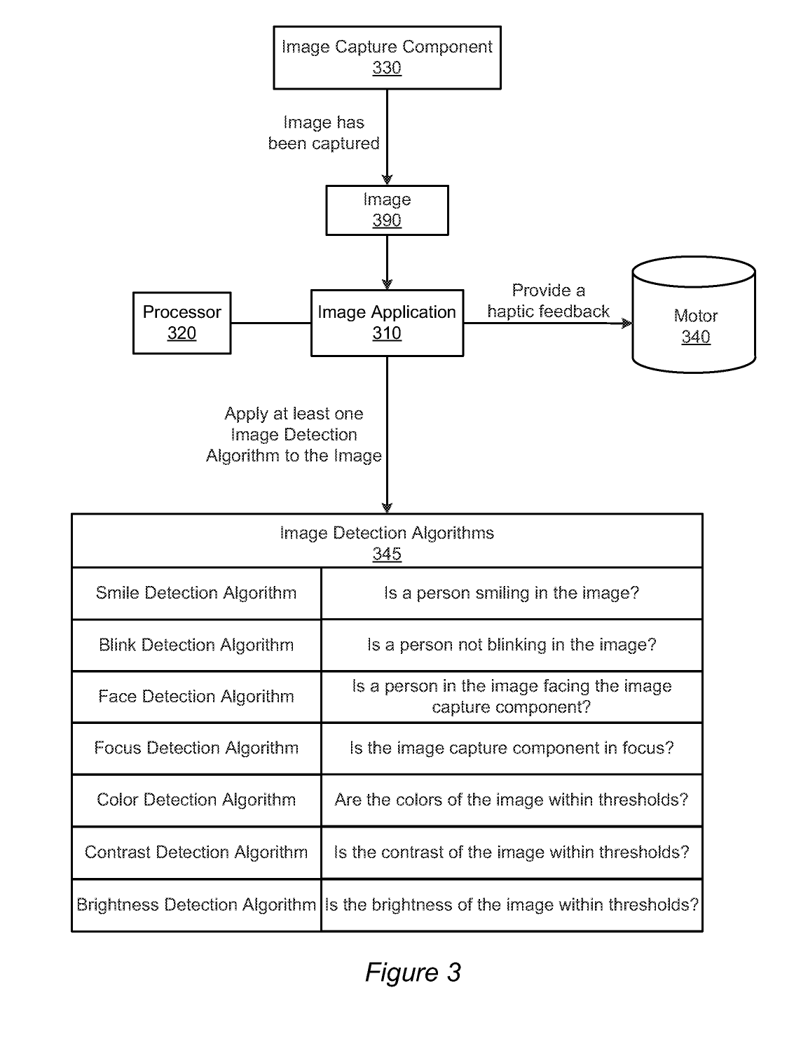

FIG. 3 illustrates a block diagram of a processor 320 determining whether an image 390 is acceptable according to an embodiment. As illustrated in the present embodiment, an image capture component 330 has captured and/or recorded an image 390. In response, the processor 320 and/or an image application 310 access the image 390 and proceed to determine whether the image 390 is acceptable or unacceptable. As noted above, when determining whether the image 390 is acceptable or unacceptable, the processor 320 and/or the image application 310 can apply one or more image detection algorithms 345 to the image 390.

The processor 320 and/or the image application 310 can determine that an image 390 is acceptable if the image 390 passes one or more of the image detection algorithms 345. In another embodiment, the processor 320 and/or the image application 310 can determine that the image 390 is acceptable if the image 390 passes all of the image detection algorithms 345. In other embodiments, the image 390 can be determined to be acceptable if the image 390 passes a predefined number of image detection algorithms 345. The predefined number can be defined by the processor 320, the image application 310, and/or by a user of the device.

The processor 320 and/or the image application 310 can determine that the image 390 is unacceptable if the image 390 fails one or more of the image detection algorithms 345. In another embodiment, the processor 320 and/or the image application 310 can determine that the image 390 is unacceptable if the image 390 fails all of the image detection algorithms 345. In other embodiment, the image 390 can be unacceptable if the image fails a predefined number of image detection algorithms 345.

As illustrated in FIG. 3, one or more image detection algorithms 345 can include a smile detection algorithm, a blink detection algorithm, a face detection algorithm, a focus detection algorithm, a color detection algorithm, a contrast detection algorithm, and/or a brightness detection algorithm. In other embodiments, one or more image detection algorithms 345 can include additional algorithms which can be applied to an image 390 for the processor 320 and/or the image application 310 to determine whether the image 390 is acceptable or unacceptable.

One or more of the image detection algorithms 345 can be stored and accessible on one or more locations on the device. In one embodiment, one or more of the image detection algorithms 345 can be stored as a list, as a database, and/or as a file. As illustrated in FIG. 3, one or more of the image detection algorithms 345 can include corresponding conditions or rules which the processor 320 and/or the image application 310 apply to an image 390 when determining whether the image 390 passes or fails the corresponding image detection algorithm 345.

In one embodiment, when determining which of the image detection algorithms 345 to apply to an image 390, the processor 320 and/or the image application 310 can identify a mode of operation of the device. The device can include an automatic mode, a portrait mode, a macro mode, a landscape mode, and/or a sports mode. If the device is in an automatic mode, the processor 320 and/or the image application 310 proceed to apply all of the image detection algorithms 345 to the image 390.

If the device is in a portrait mode, the processor 320 and/or the image application 310 can proceed to apply the smile detection algorithm, the blink detection algorithm, the face detection algorithm, and/or the focus detection algorithm. When applying the blink detection algorithm, the processor 320 and/or the image application 310 can use eye detection technology to determine whether a person's eyes in the image 390 is open or closed. When applying the face detection algorithm, the processor 320 and/or the image application 310 can utilize facial detection technology to determine whether the user is facing the image capture component 330.

If the device is in the macro mode, the sports mode, or the landscape mode, the processor 320 and/or the image application 310 can proceed to apply the focus detection algorithm, the color detection algorithm, the contrast detection algorithm, and/or the brightness detection algorithm. In other embodiment, the device can include additional modes and the processor 320 and/or the image application 310 can determine to apply one or more image detection algorithms 345 to the image 390 in response to the additional mode of the device.

In another embodiment, when determining which of the image detection algorithms 345 to apply to an image 390, the processor 320 and/or the image application 310 can determine whether the image 390 includes one or more people in the image 390. When determining whether the image 390 includes one or more people, the processor 320 and/or the image application 310 can use facial detection technology and/or eye detection technology on the image 390.

In one embodiment, if the image 390 includes one or more people, the processor 320 and/or the image application 310 can proceed to apply the smile detection algorithm, the blink detection algorithm, the focus detection algorithm, and/or the focus detection algorithm. As a result, the processor 320 and/or the image application 310 will proceed to determine whether a person in the image 390 is smiling, whether a person in the image 390 is blinking, whether a person in the image 390 is facing the image capture component 330, and/or whether the image capture component 330 is in focus.

In another embodiment, if the image 390 does not include one or more people, the processor 320 and/or the image application 310 can proceed to apply the focus detection algorithm, the color detection algorithm, the contrast detection algorithm, and/or the brightness detection algorithm. As a result, the processor 320 and/or the image application 310 can proceed to determine whether the image capture component 330 is in focus, whether the colors of the image 390 are within acceptable thresholds, whether the contrast of the image 390 is within acceptable thresholds, and/or whether the brightness of the image 390 is within acceptable thresholds. The thresholds for the color, contrast, and/or brightness algorithms can be predefined by the processor 320, the image application 310 and/or by a user of the device.

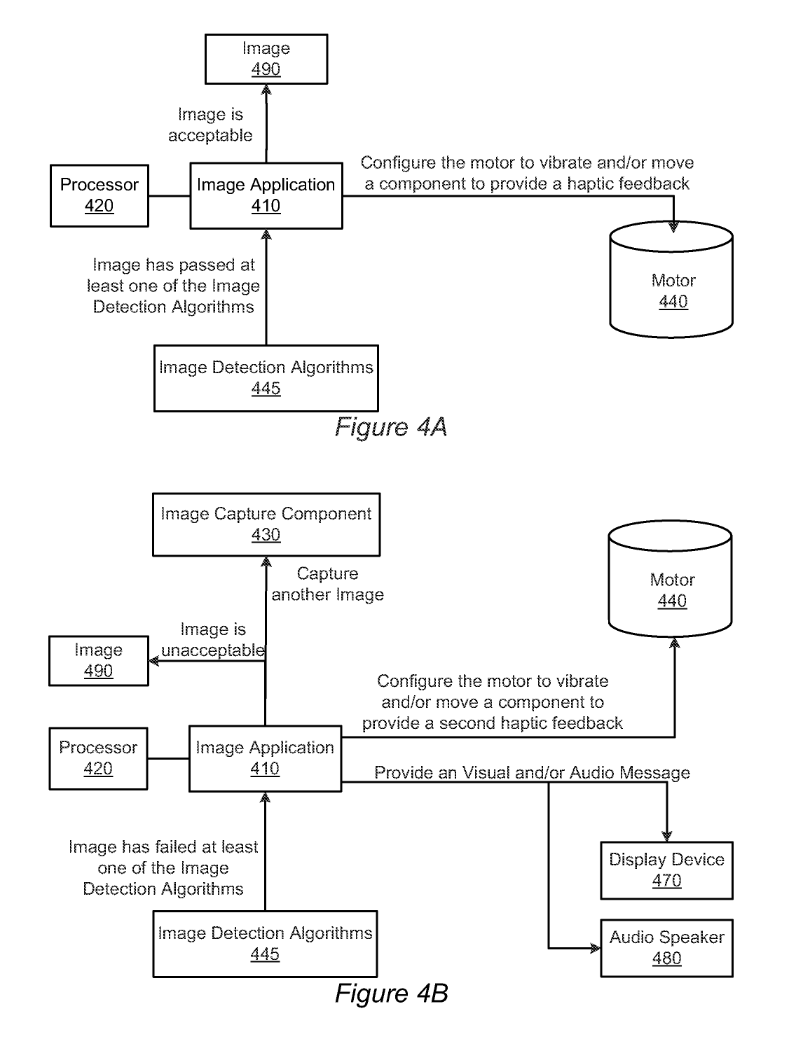

FIG. 4A illustrates a block diagram of a motor 440 providing a haptic feedback response in response to a processor 420 determining that an image 490 is acceptable according to an embodiment. As noted above, an image 490 can be determined to be acceptable in response to the processor 420 and/or the image application 410 determining that the image 490 passes one or more image detection algorithms 445. As illustrated in the present embodiment, the processor 420 and/or the image application 410 have applied one or more image detection algorithms 445 to the image 490 and have determined that the image 490 has passed one or more of the image detection algorithms 445.

As a result, the image 490 is determined to be acceptable. In response to the processor 420 and/or the image application 410 proceed to configure the motor 440 to provide a haptic feedback response to a user of the device. As noted above, when providing a haptic feedback response with the motor 440, the motor 440 can be configured to vibrate and/or move or apply force to the device or one or more components of the device.

In one embodiment, the haptic feedback response can include the motor 440 providing one or more short vibrations, one or more long vibrations, and/or a combination of the above. As a result, the user of the device can feel a response from the device and be notified that the image is acceptable. In another embodiment, the haptic feedback response includes the motor 440 moving or rotating. By moving or rotating the motor 440 without providing a vibration, an amount of noise generated by the motor 440 and/or the device can be reduced. Additionally, an amount of power used by the motor 440 and/or the device can be reduced. As a result, the user can be passively be notified with a haptic feedback response without disturbing other people around the user and conserving power on the device.

FIG. 4B illustrates a block diagram of a motor 440 providing a second haptic feedback response in response to a processor 420 determining that an image 490 is unacceptable according to an embodiment. As noted above, an image 490 is determined to be unacceptable if the image 490 fails one or more image detection algorithms 445. In one embodiment, the processor 420 and/or the image application 410 determine that the image 490 includes two people. In response the processor 420 and/or the image application 410 proceed to apply a smile detection algorithm, a blink detection algorithm, a face detection algorithm, and a focus detection algorithm.

The processor 420 and/or the image application determine that the image capture component is in focus and both of the people in the image 490 are facing the image capture component. Additionally, the processor 420 and/or the image application 410 determine that one of the people in the image 490 has their eyes close and the other person is not smiling. As a result, the processor 420 and/or the image application 410 determine that the image 490 has passed the focus detection algorithm and the face detection algorithm. The processor 420 and/or the image application 410 additionally determine that the image 490 has failed the smile detection algorithm and the blink detection algorithm.

As a result, the image 490 is determined to be unacceptable. In response, the processor 420 and/or the image application 410 proceed to configure the motor 440 to provide a second haptic feedback response to a user of the device. As noted above, the second haptic feedback response can include one or more short vibration or motions, one or more long vibrations or movements, and/or a combination of the above. In one embodiment, the second haptic feedback response can be different from a haptic feedback response provided if the image 490 is acceptable. As a result, the user of the device can distinguish between one or more haptic feedback responses and accurately be notified when an image 490 is acceptable and/or when the image 490 is unacceptable.

In one embodiment, the device can also include a display device 470 and/or an audio speaker 480. The processor 420 and/or the image application 410 can prompt the display device 470 and/or the audio speaker 480 to output one or more visuals or audio messages. As noted above, one or more messages can supplement a haptic feedback response and can specify which of the image detection algorithms 445 the image 490 failed and/or which of the objects or people within the image 490 failed an image detection algorithm 445. In one embodiment, one or more of the messages can indicate that the image 490 failed the smile detection algorithm and the blink detection algorithm. In another embodiment, one or more messages can indicate that one of the people failed the smile detection algorithm, while the other person failed the blink detection algorithm.

As illustrated in FIG. 4B, the processor 420 and/or the image application 410 can additionally instruct the image capture component 430 to capture another image in response to determining that the image 490 is unacceptable. Once another image has been captured, the processor 420 and/or the image application 410 can proceed to apply one or more of the image detection algorithms 445 to the other image. The processor 420 and/or the image application 410 can repeat this process until a captured image is determined to be acceptable.

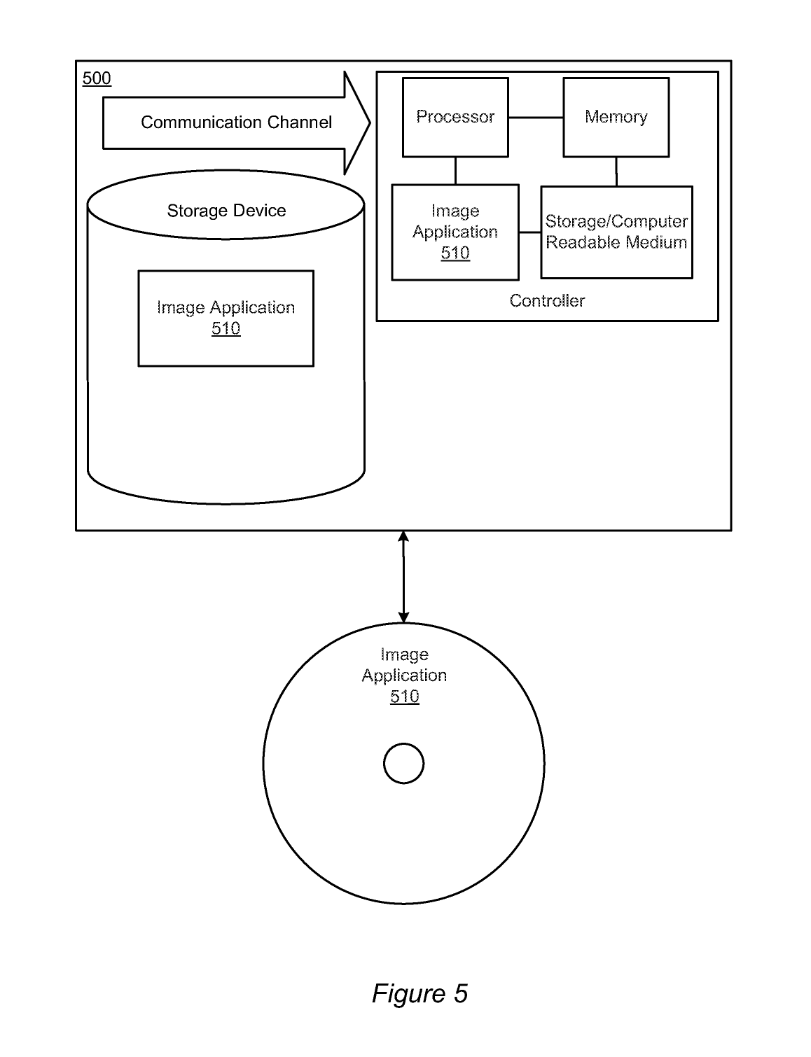

FIG. 5 illustrates an image application 510 on a device 500 and the image application 510 stored on a removable medium being accessed by the device 500 according to an embodiment. For the purposes of this description, a removable medium is any tangible apparatus that contains, stores, communicates, or transports the application for use by or in connection with the device 500. As noted above, in one embodiment, the image application 510 is firmware that is embedded into one or more components of the device 500 as ROM. In other embodiments, the image application 510 is an application which is stored and accessed from a hard drive, a compact disc, a flash disk, a network drive or any other form of computer readable medium that is coupled to the device 500.

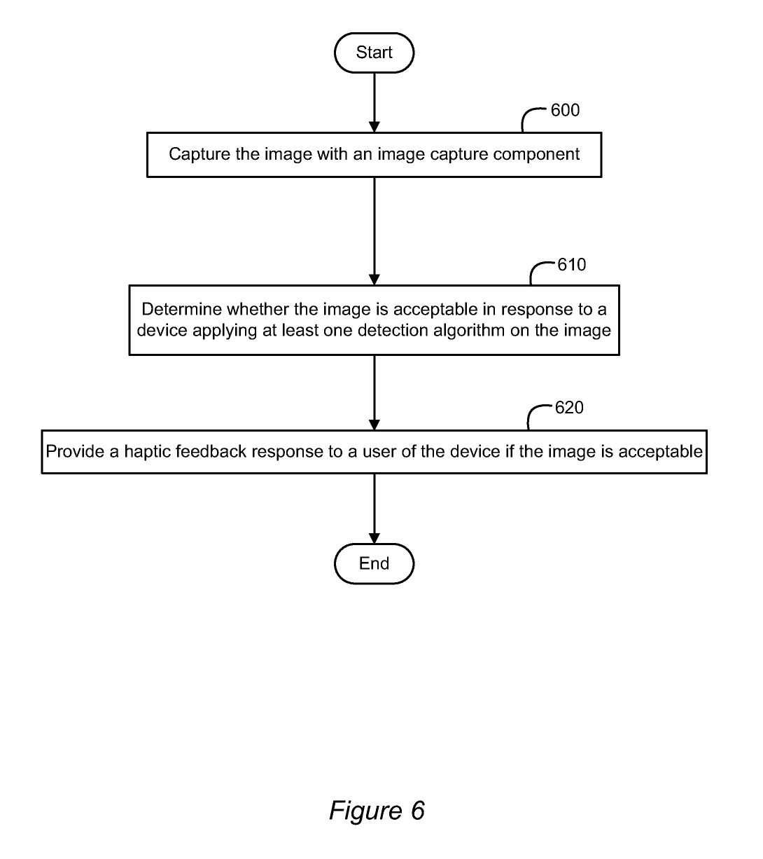

FIG. 6 is a flow chart illustrating a method for providing feedback for an image according to an embodiment. The method of FIG. 6 uses a device with a processor, a motor, an image capture component, a communication channel, and/or an image application. In other embodiments, the method of FIG. 6 uses additional components and/or devices in addition to and/or in lieu of those noted above and illustrated in FIGS. 1, 2, 3, 4, and 5.

As noted above, the image application is an application which can be used independent and/or in conjunction with the processor to manage the device. In one embodiment, the image application can be a firmware of the device. The image capture component can initially capture one or more images of objects, people, and/or scenes within a view of the image capture component 600.

The image capture component is a device or component which can manually or automatically capture one or more images in response to a user accessing an input device and/or in response to the processor and/or the image application detecting an event occurring. As noted above, the event can be a predefined amount of time elapsing or the image capture component detecting one or more people within a view of the image capture component.

In response to one or more images being captured, the processor and/or the image application can proceed to determine whether the image is acceptable by applying one or more image detection algorithms to the image 610. One or more image detection algorithms can include tests, such as a smile detection algorithm, a blink detection algorithm, a face detection algorithm, a focus detection algorithm, a contrast detection algorithm, a color detection algorithm, and/or a brightness detection algorithm. When applying one or more of the image detection algorithms, the processor and/or the image application can use face detection technology and/or eye detection technology. In other embodiments, the processor and/or the image application can apply additional algorithms and/or tests in addition to and/or in lieu of those noted above when determining whether an image is acceptable.

When determining which of the image detection algorithms to apply, the processor and/or the image application can identify a mode of operation of the device. As noted above, the device can include an automatic mode, a portrait mode, a macro mode, a scene mode, and/or a sports mode. In response to a mode which the device is currently in, the processor and/or the image application can choose one or more of the image detection algorithms to apply to the image.

The processor and/or the image application can determine that the image is acceptable if the image passes one or more of the image detection algorithms. In another embodiment, the image can be determined to be acceptable if the image passes all or a predefined amount of the image detection algorithms. The processor and/or the image application can determine that the image is unacceptable if the image fails one or more of the image detection algorithms. In other embodiments, the image can be determined to be unacceptable if the image fails all or a predefined amount of the image detection algorithms.

Once the image has been determined to be acceptable or unacceptable, the processor and/or the image application can configure a motor of the device to provide a haptic feedback response. The motor is a device or component which can vibrate and/or move or apply force to the device or one or more components of the device when generating one or more haptic feedback responses. As noted above, a haptic feedback response is a tactile feedback which a user of the device can feel when holding the device or when the device is touching one or more parts of the user's body.

If the image is determined by the processor and/or the image application to be acceptable, the motor can proceed to provide a haptic feedback response 620. In another embodiment, if the image is determined to be unacceptable, the motor can proceed to provide a second haptic feedback response. As noted above, a haptic feedback response provided by the motor can be different from a second haptic feedback response provided. The method is then complete. In other embodiments, the method of FIG. 6 includes additional steps in addition to and/or in lieu of those depicted in FIG. 6.

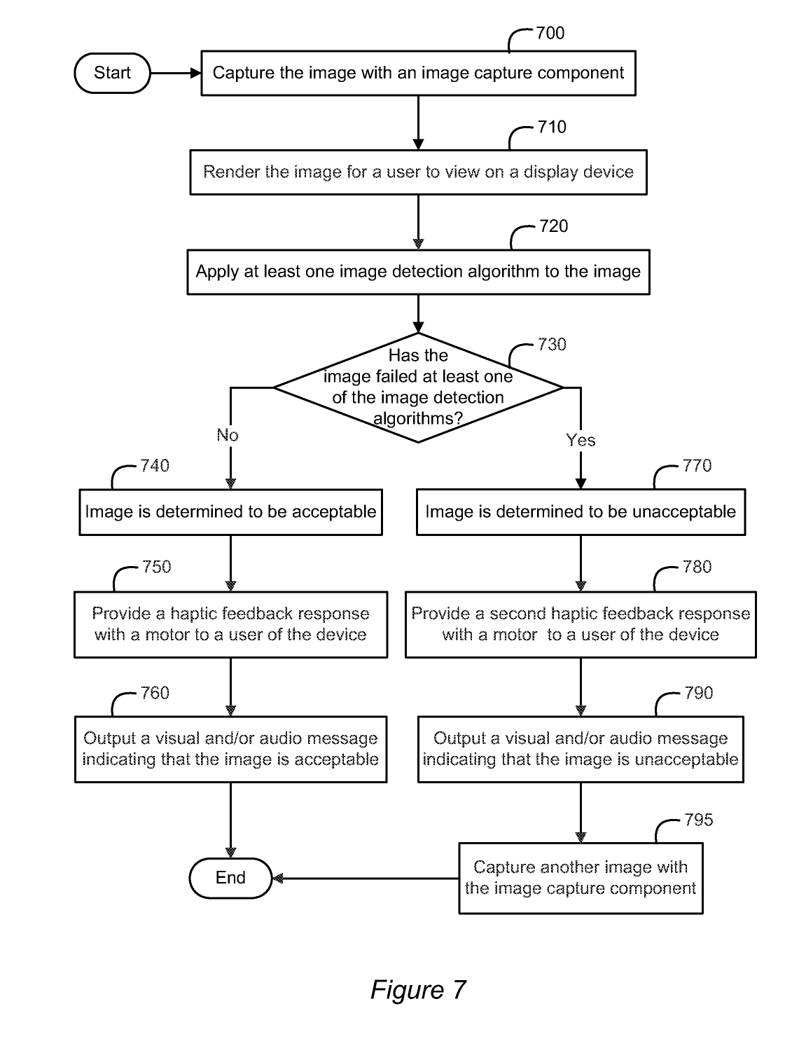

FIG. 7 is a flow chart illustrating a method for providing feedback for an image according to another embodiment. Similar to the method disclosed above, the method of FIG. 7 uses a device with a processor, a motor, an image capture component, a communication channel, and/or an image application. In another embodiment, the device also uses a display device and/or an audio speaker. In other embodiments, the method of FIG. 7 uses additional components and/or devices in addition to and/or in lieu of those noted above and illustrated in FIGS. 1, 2, 3, 4, and 5.

The image capture component can initially capture one or more images 700. As noted above, the image capture component can proceed to capture one or more objects, people, and/or scenes within a view of the image capture component in response to a user accessing an input device of the device. In another embodiment, the processor and/or the image application can instruct the image capture component to capture one or more images after a predefined amount of time has elapsed and/or in response to an event being detected.

In one embodiment, the processor and/or the image application can also render an image for view on a display device of the device 710. The display device can be coupled to one or more locations on the device. In one embodiment, the display device can include a LCD display, a LED display, a CRT display, a Plasma display, and/or a projector. The processor and/or the image application can then proceed to apply one or more image detection algorithms to the image 720.

One or more image detection algorithms can include tests which determine whether a person in the image is smiling, whether a person in the image is blinking, whether a person in the image is facing the image capture component, whether the image capture component is in focus, whether a color of the image is within thresholds, whether a contrast of the image is within thresholds, and/or whether a brightness of the image is within thresholds. In other embodiments, additional image detection algorithms can be applied to determine additional conditions of the image in addition to and/or in lieu of those noted above.

The processor and/or the image application can determine whether the image has failed one or more of the image detection algorithms 730. In one embodiment if the image has not failed one or more of the image detection algorithms, the processor and/or the image application can proceed to determine that the image is acceptable 740. In another embodiment, the processor and/or the image can determine that the image is acceptable if the image passes all or a predefined amount of image detection algorithms.

The processor and/or the image application can then configure the motor to provide a haptic feedback response to a user of the device 750. As noted above, the motor can generate vibrations and/or move or apply force to the device or one or more components of the device when generating a haptic feedback response. In one embodiment, the processor and/or the image application can additionally output a visual and/or an audio message through a display device or an audio speaker indicating that the image is acceptable 760.

In another embodiment, if the image previously failed one or more of the image detection algorithms, the processor and/or the image application can determine that the image is unacceptable 770. In other embodiments, the processor and/or the image can determine whether the image has failed all or a predefined amount of the image detection algorithms before determining that the image is unacceptable. The processor and/or the image application can then configure the motor to provide a second haptic feedback response to a user of the device 780.

In one embodiment, the processor and/or the image application can further configure the display device and/or the audio speaker to output a visual and/or an audio message indicating that the image is unacceptable 790. In one embodiment, one or more of the messages can specify which of the image detection algorithms the image failed and/or which object or person failed a corresponding image detection algorithm. The method is then complete. In other embodiments, the method of FIG. 7 includes additional steps in addition to and/or in lieu of those depicted in FIG. 7.

What is claimed is:

1. A method for providing feedback for an image comprising:
capturing the image with an image capture component;
determining whether the image is acceptable in response to a device applying at least one image detection algorithm on the image; and
providing a haptic feedback response to a user of the device if the image is acceptable.

2. The method for providing feedback for an image of claim 1 wherein the image is determined to be acceptable if the image passes at least one of the image detection algorithms.

3. The method for providing feedback for an image of claim 1 wherein the image is determined to be unacceptable if the image fails at least one of the image detection algorithms.

4. The method for providing feedback for an image of claim 3 further comprising providing a second haptic feedback response to the user of the device if the image is unacceptable.

5. The method for providing feedback for an image of claim 2 wherein the image passes at least one of the image detection algorithms if the device detects a person in the image smiling.

6. The method for providing feedback for an image of claim 2 wherein the image passes at least one of the image detection algorithms if the device determines that a person in the image is not blinking.

7. The method for providing feedback for an image of claim 2 wherein the image passes at least one of the image detection algorithms if the device determines that a person is facing the image capture device.

8. The method for providing feedback for an image of claim 2 wherein the image passes at least one of the image detection algorithms if the image capture device is in focus.

9. A device comprising:
an image capture component to capture an image;
a motor to provide a haptic feedback response with the device; and
a processor to apply at least one image detection algorithm to determine whether the image is acceptable and provide the haptic feedback response with the motor to a user of the device if the image is determined to be acceptable.

10. The device of claim 9 wherein an image detection algorithm includes at least one from the group consisting of a smile detection algorithm, a blink detection algorithm, a face detection algorithm, a focus detection algorithm, a contrast detection algorithm, a color detection algorithm, and a brightness detection algorithm.

11. The device of claim 10 wherein the processes uses at least one from the group consisting of facial detection technology and eye detection technology when applying at least one of the image detection algorithms.

12. The device of claim 9 wherein the haptic feedback response includes a vibration from the motor.

13. The device of claim 9 wherein the haptic feedback response includes the motor moving a component of the device.

14. The device of claim 9 further comprising a display device to render the image for view.

15. The device of claim 14 wherein the processor uses the display device to render a visual message in response to determining whether the image is acceptable.

16. The device of claim 9 further comprising an audio speaker to output an audio message in response to determining whether the image is acceptable.

17. A computer readable medium comprising instructions that if executed cause a processor to:
capture an image with an image capture component of a device;
determine whether the image is acceptable by applying at least one image detection algorithm on the image; and
provide a haptic feedback response to a user of the device if the image is determined to be acceptable.

18. The computer readable medium comprising instructions of claim 17 wherein the processor provides a second haptic feedback response to the user of the device if the image fails at least one of the image detections algorithms and the haptic feedback response is different from the second haptic feedback response.

19. The computer readable medium comprising instructions of claim 17 wherein the processor determines which of the image detection algorithms to apply to the image based on a mode of operation of the device.

20. The computer readable medium comprising instructions of claim 17 wherein the processor uses the image capture component to capture another image if the image was not acceptable.
